(19) United States
(12) Patent Application Publication
(10) Pub. No.: US 2013/0117671 A1
(43) Pub. Date: May 9, 2013

(54) METHODS AND SYSTEMS FOR EDITING VIDEO CLIPS ON MOBILE DEVICES

(71) Applicant: Triparazzi, Inc., New York, NY (US)

(72) Inventors: Daniel Raymond Long, Brooklyn, NY (US); Demir Dustin Gjokaj, Brooklyn, NY (US)

(73) Assignee: TRIPARAZZI, INC., New York, NY (US)

(21) Appl. No.: 13/660,744

(22) Filed: Oct. 25, 2012

Related U.S. Application Data
(60) Provisional application No. 61/551,197, filed on Oct. 25, 2011.
(60) Provisional application No. 61/711,989, filed on Oct. 10, 2012.

(51) Int. Cl. G06F 3/00

(52) U.S. Cl. 715/725

(57) ABSTRACT

Computer-implemented methods, systems, and programs are provided for creating and editing video content on mobile devices.

### CROSS REFERENCE TO RELATED APPLICATIONS

This application claims priority from (1) U.S. Provisional Patent Application No. 61/551,197 filed on Oct. 25, 2011 entitled METHOD AND SYSTEM FOR CREATING VIDEO CONTENT ON MOBILE DEVICES and (2) U.S. Provisional Patent Application No. 61/711,989 filed on Oct. 10, 2012 entitled METHODS AND SYSTEMS FOR CREATING VIDEO CONTENT ON MOBILE DEVICES, both of which are hereby incorporated herein by reference.

### BACKGROUND

The present application relates to methods and systems for creating video content on mobile devices equipped with cameras such as cell phones, smart phones, and tablet computers.

### BRIEF SUMMARY OF THE DISCLOSURE

In accordance with one or more embodiments, computer-implemented methods, systems, and application programs are provided for generating video content on a mobile device equipped with a camera. The method includes the steps of: (a) presenting a storyboard template on a display of a mobile device operated by a user, said storyboard template comprising an arrangement of scene elements forming a guide for capturing video clips or still images for the video content; (b) activating the camera on the mobile device after selection by the user of a particular scene element in the storyboard template, thereby enabling the user to capture a plurality of video clips or still images, each associated with one of the scene elements in the storyboard template; and (c) generating the video content by combining the video clips or still images captured by the user in the storyboard template in a given order.

In accordance with one or more further embodiments, computer-implemented methods, systems, and application programs are provided for generating and editing video content on a mobile device equipped with a camera and operated by a user. The method includes the steps of: (a) generating video content by combining a plurality of video clips or still images captured by the camera in an initial given order; (b) displaying the video content to the user on a display of the mobile device; (c) receiving an input from the user to shuffle the video clips or still images in the video content; and (d) generating edited video content by combining the video clips or still images in an order different from the initial given order.

In accordance with one or more further embodiments, computer-implemented methods, systems, and application programs are provided for editing a video clip on a mobile device. The method includes the steps of: (a) presenting a video clip editing interface on a display of a mobile device operated by a user, said video clip editing interface including a section playing a video clip to be edited, said video clip editing interface also including an inline editing feature, said inline editing feature comprising a clip preview section displaying a series of selected stills depicting the video clip in time and one or more trim handles at the clip preview section; (b) receiving a user input dragging the one or more trim handles to select a portion of the video clip to be trimmed; and (c) pausing the video clip playing in the video clip editing interface while the user is engaging a trim handle, and resuming playing the video clip once the user is no longer engaging a trim handle without playing any portions of the video clip trimmed by the user.

### BRIEF DESCRIPTION OF THE DRAWINGS

FIG. 1 is a screenshot illustrating an exemplary Projects screen in accordance with one or more embodiments.

FIG. 2 is a screenshot illustrating an exemplary Storyboard Selection screen in accordance with one or more embodiments.

FIG. 3 is a screenshot illustrating an exemplary Storyboard screen in accordance with one or more embodiments.

FIG. 4 is a screenshot illustrating an exemplary Compose Shot screen in accordance with one or more embodiments.

FIG. 5 is a screenshot illustrating an exemplary Tutorial screen in accordance with one or more embodiments.

FIG. 6 is a screenshot illustrating an exemplary Edit Room screen in accordance with one or more embodiments.

FIG. 7 is a screenshot illustrating an exemplary Add Soundtrack screen in accordance with one or more embodiments.

FIG. 8 is a screenshot illustrating an exemplary Final Preview screen in accordance with one or more embodiments.

FIG. 9 is a screenshot illustrating an exemplary Finish screen in accordance with one or more embodiments.

FIG. 10 is a screenshot illustrating another exemplary storyboard screen in accordance with one or more embodiments.

FIG. 11 is a screenshot illustrating an exemplary viewfinder screen with a semitransparent image overlay in accordance with one or more embodiments.

FIG. 12 is a screenshot illustrating an exemplary screen for rearranging tiles in accordance with one or more embodiments.

FIG. 13 is a screenshot illustrating an exemplary screen showing the tiles of FIG. 12 rearranged in accordance with one or more embodiments.

FIG. 14 is a screenshot illustrating an exemplary screen illustrating an in-line editing feature in accordance with one or more embodiments.

FIG. 15 is a screenshot illustrating an exemplary screen showing a video clip edited using the in-line editing feature in accordance with one or more embodiments.

### DETAILED DESCRIPTION

The present application is directed to methods and systems for creating video content on mobile devices equipped with cameras. Such mobile devices can include, without limitation, cell phones, personal digital assistants, smart phones (e.g., the Apple iPhone and Android-based smart phones), and tablet computers (e.g., the Apple iPad tablet). The mobile devices include operating systems (e.g., Android, Apple iOS, and Windows Phone OS, among others) on which applications run. The operating systems allow programmers to create applications (often called “Apps”) to provide particular functionality to the devices. This functionality is often the synthesis of (1) proprietary software, and (2) proprietary cloud-supported data and functionality, (3) open-source operating system technology, and (4) proprietary hardware owned by the creator of the device.

A representative mobile device includes at least one computer processor, a storage medium readable by the processor for storing applications and data. The mobile device also includes input/output devices including a camera integrated or removably attached to the mobile device, one or more speakers for acoustic output, a microphone for acoustic input, and a display for visual output, e.g., an LCD or LED display, which can have touch screen input capabilities. The mobile device may include a communication module to communicate with other devices via telecommunications and other networks. The mobile device is powered by a battery or other power supply.

Mobile device users typically shoot video indiscriminately. Producing stylistic, professional-looking video content on mobile devices is difficult and time-consuming. In accordance with one or more embodiments, a video content system is provided that enables users to systematically capture, edit, and compile video footage on their mobile devices to quickly and easily create professional-looking video content. The system is preferably implemented in software executed on the mobile devices. By way of example, the software can be an App installed on a mobile device.

The video content system provides users with a storyboard, which is a template that guides users through the video creation process. The storyboard includes an arrangement of scene elements that can be selected for creating a narrative for the video content. It allows users to identify and capture significant story points when shooting the video, thereby significantly reducing or eliminating the time and effort needed to edit video footage. The storyboard allows users to see their videos taking shape from the very first shot. Users can create a finished video by combining the story points from the storyboard.

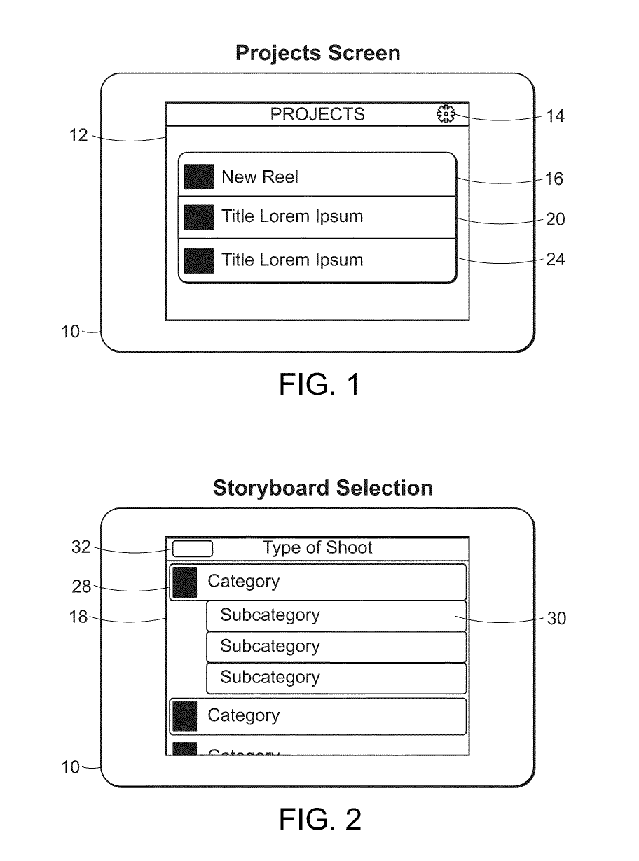

FIGS. 1-9 are exemplary screenshots shown on a display of a mobile device 10 to illustrate one example of how a video system in accordance with one or more embodiments can be used to create video content. It should be understood that the screenshots are provided as examples only, and that a variety of modifications can be made to achieve the same or similar functionality.

FIG. 1 illustrates an exemplary Projects screen 12 shown to the user. This screen allows the user to start a new video project or access existing projects in various stages of completion.

The screen includes a Settings button 14, which takes the user to a settings screen where he or she can modify account settings.

The user can select the New Reel option 16, which has a given default icon or logo. Selection of this option allows the user to start a new project and takes the user to a Storyboard Selection screen 18 (FIG. 2) where he or she can see different types of the clips that can be taken.

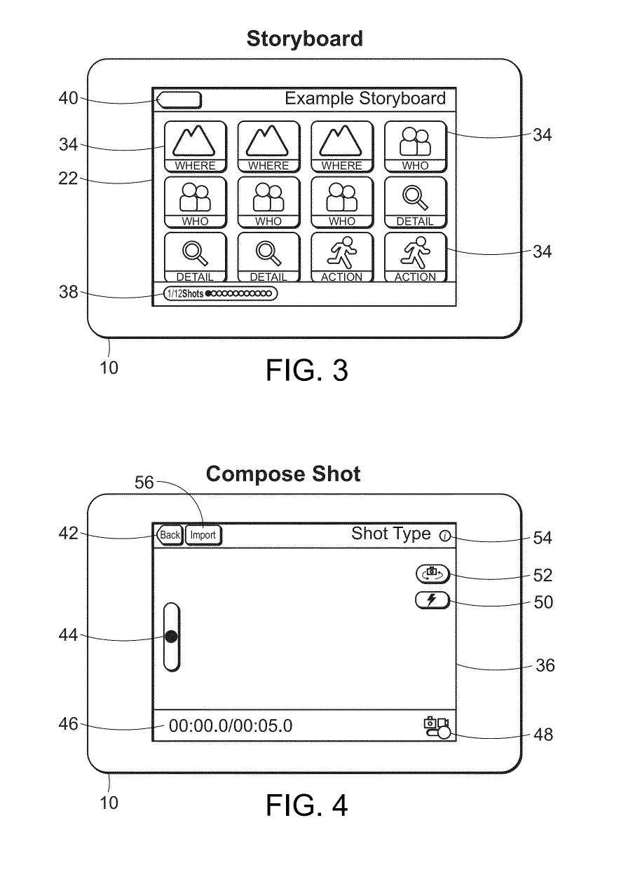

The user can also select an existing project option 20, 24, which shows the first frame of the first clip as its icon and a title, if there is one. The project 20 may be an incomplete project indicated, e.g., in yellow text. The user can be shown the number of taken clips out of the total number of clips needed for the project. The total number of clips needed will match the number of empty boxes shown in the Storyboard screen 22 (shown in FIG. 3). Clicking on an existing project option in FIG. 1 takes the user to the Storyboard screen 22, where the user can see the clips already taken along with the clips still needed to be taken.

The user can also select a finished project 24. This option can be shown, e.g., in green text to indicate a completed status. Selecting this option takes the user to a Play Review screen 26 (shown in FIG. 8).

FIG. 2 illustrates an exemplary Storyboard Selection screen 18. This screen identifies categories 28 of different storyboard templates that can be used for a project. Each of the category options can show a default clip image. It also includes a title indicating the type of storyboard along with explanatory text about what types of storyboards this option would include. Clicking on a category option 28 opens a drop-down to subcategory options 30.

The selection of a particular subcategory option 30 in FIG. 2 selects the particular storyboard to be used. The option includes a title and explanatory text describing when it should be used. Clicking on this option sends the user to the Storyboard screen 22 (FIG. 3). The following table provides some non-limiting examples of storyboard categories and subcategories. Various other storyboard categories and subcategories are, of course, possible.

| STORYBOARD | STORYBOARD NAME |
|---|---|
| CATEGORY | (SUBCATEGORY) |
| Events | Wedding |
| Events | Live Music |
| Events | Cultural Event |
| Events | Around Town |
| Events | Sporting Event |
| Review | Restaurant |
| Review | Shopping/Fashion |
| Family | Birth |
| Family | Wedding |
| Family | Baby Shower |
| Family | Birthday |
| Family | Family Dinner |
| Family | Family Holiday |
| Party Time | Party |
| Party Time | Birthday |
| Home | Cooking |
| Home | Gardening |
| Home | Repairs/Improvement |
| Personal | Dating Profile |
| Personal | Video Greeting Card |
| Personal | Video Resume |
| Personal | Classified: Sell Your Item |
| Journalism | News Report |
| Journalism | Interview |
| Journalism | Weather Report |
| Business | Commercial |
| Travel | Vacation |
| Review | Hotel Review |
| Review | Concert Review |
| Review | Night Life |
| Review | Street Fair |
| Review | Cultural Events |
| Review | Products and Services |
| Family | Day in The Life |
| Family | Family Outing |
| Family | Holidays with the Family |
| Family | Family Vacation |
| Family | Weekends ... |
| Family | On The Go |
| Family | Birthdays |
| Kids | She's Having a Baby Soon ... |
| Kids | Baby Shower |
| Kids | It's Happening! |
| Kids | Baby Video |
| Kids | Birthdays |
| Kids | Play Dates |
| Kids | Sports Events |
| Kids | Theater/Dance Events |
| Kids | Kids Movie |
| Party Time | In Da Club |
| Party Time | House Party |
| Party Time | BBQ/Picnic |
| Party Time | Pool Party |
| Party Time | Vegas Baby! |
| Party Time | Frat Party |
| Party Time | Bachelor Party |
| Party Time | Beach Party |
| Party Time | Sunday Brunch |
| Business | Review |
| Business | Product Featurette |
| Business | Service Featurette |
| Business | About Your Business |
| Business | Classified Listing |
| Realtor | About the Neighborhood ... |
| Realtor | Overview of the Home |
| Realtor | Details and Amenities |
| Realtor | About You: Our Broker |
| Cooking | Shopping for Ingredients |
| Cooking | Preparation/Setup |
| Cooking | Cooking |
| Cooking | Presentation |
| Travel | Getting There |
| Travel | Where to Stay |
| Travel | Sightseeing/Tours |
| Travel | Museums/Cultural |
| Travel | Exotic Food |
| Travel | Shopping/Markets |
| Travel | Rest and Relaxation |
| Travel | Road Trip |
| Wedding | Bridal Shower |
| Wedding | Bachelor(ette) Party |
| Wedding | Rehearsal Dinner |
| Wedding | Behind the Scenes |
| Wedding | Wedding |
| Wedding | Reception |

A Projects Button 32 in the FIG. 2 screen can be selected to take the user back to the main projects screen 12.

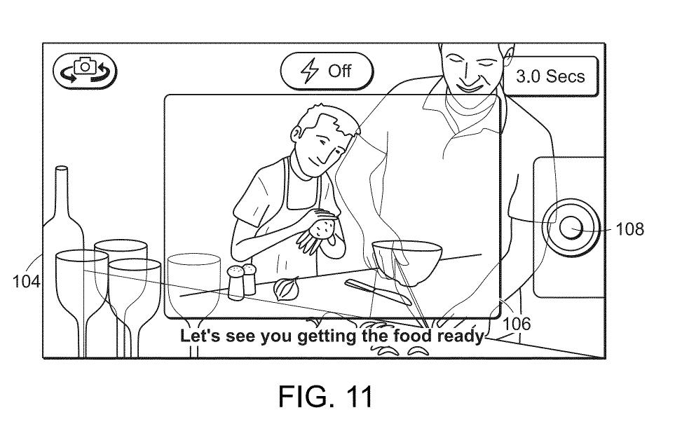

FIG. 3 illustrates one example of a Storyboard screen 22. (FIG. 11, which is discussed further below, illustrates another example of a Storyboard screen.) The storyboard screen 22 provides the user with multiple scene options indicated by an arrangement of tiles 34 on the screen detailing the type of shot the user needs to take for a given project. Selecting any one of the tiles takes the user to a Compose Shot screen 36 (FIG. 4). The type of shot detail shows the user at a glance what type of shot they are taking. After the user has completed the shot, the detail image will show the first frame of the shot in the respective tile. A shot count indicator 38 keeps track of how many shots have been completed and how many still have to be shot. A Back button 40 takes the user to the Storyboard Selection screen 18.

FIG. 4 illustrates an exemplary Compose Shot screen 36, which a user can use to capture a video clip. The screen includes a Back button 42 to take the user back to the Storyboard screen 22. It also includes a Record button 44 the user can select to begin recording. The screen also shows a Time Code 46, which indicates the current clip length and the expected clip length. For example, 00:00.0/00:10.0 means 0 seconds of a 10 second clip have been taken. In the recording mode, the left number will increment as the video is being recorded.

The Compose Shot screen 36 also includes a Still/Video button 48, which allows the user to switch between shooting still photographs and video. It also includes a Flash button 50, which can be selected to turn on a front light, if available, on the mobile device 10. The screen 36 also includes a Front Face button 52, which can be selected to turn on a self-facing camera, if available, on the mobile device 10, so the user appears on the screen. Selecting this button again turns on the front-facing camera.

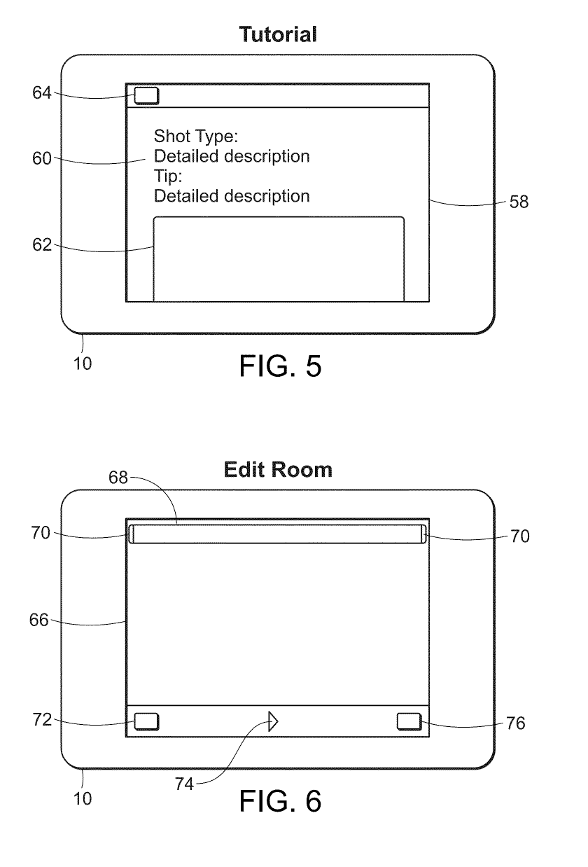

The Compose Shot screen 36 also includes an Info button 54, which takes the user to a Tutorial screen 58 (FIG. 5). Next to the Info button 54, the text of the type of scene the user is recording is shown (e.g., Where: Wide, Where: Detail, Who, etc.).

The Compose Shot screen 36 also includes an Import button 56, which allows the user to bring in footage from a camera roll on the mobile device 10. Alternately, the footage can be imported from outside the video content system application.

FIG. 5 illustrates an exemplary Tutorial Screen 58, which can provide tips and other information to the user. The screen 58 includes shot information 60, indicating the type of shot the user is taking and information about how to compose the shot. Shooting tips can be included in this information. The Tutorial screen 58 can also include an example video option 62, which can be selected to show a video, either in full-screen or in a smaller size embedded in the information. A Back button 64 takes the user to the Compose Shot screen 36.

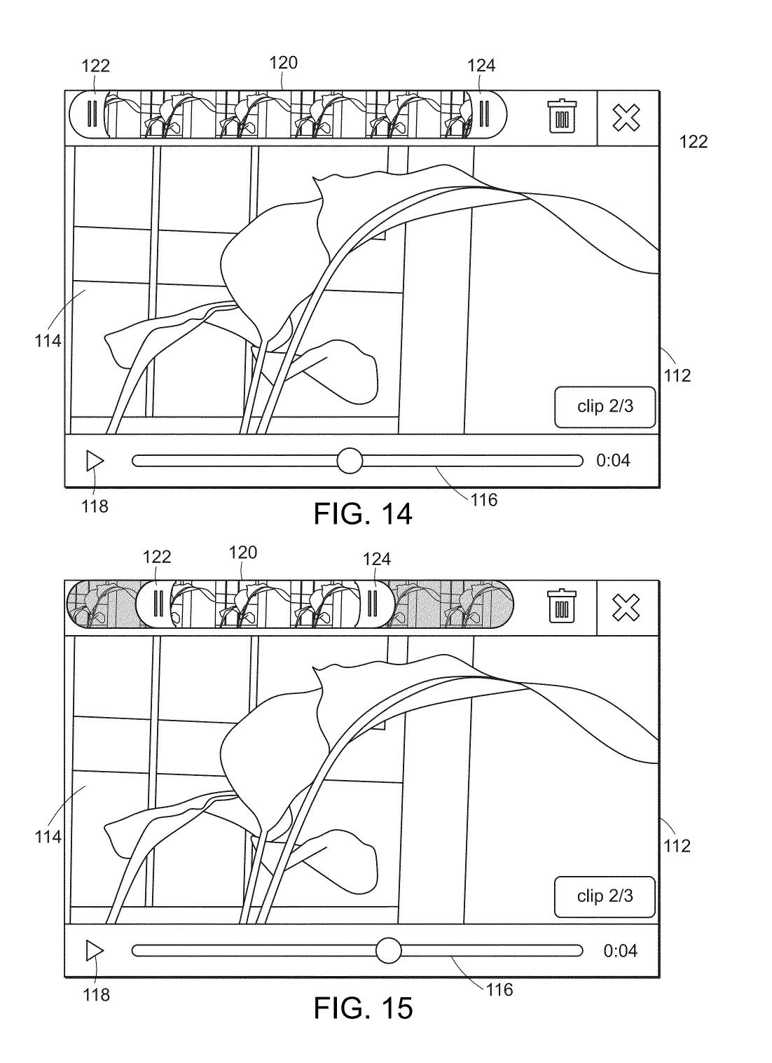

FIG. 6 illustrates an exemplary Edit Room screen 66, which allows the user to edit a video clip. The screen includes a Clip Preview section 68, which shows the user a selection of stills from the video clip just shot. The Clip Preview section 68 includes Clip Handles 70. As discussed below in connection with FIGS. 14 and 15, the user can grab the edges of the preview to crop the clip. A bar around the video stills will narrow to the clipped version. The screen can also include a Retake button 72, which can be selected to return the user to the Compose Shot screen 36 where the user can re-shoot the clip.

The Edit Room screen also includes a Play button 74, which can be selected to play the video clip. The Play button 74 will turn to a Pause button when the clip is playing. When the clip is paused, the button appears as a Play button. lithe user has cropped the video clip, selecting play will preview the cropped clip rather than the full clip.

The Edit Room screen can also include a Done button 76, which can be selected to return the user to the Storyboard screen 22, with the new clip saved in place.

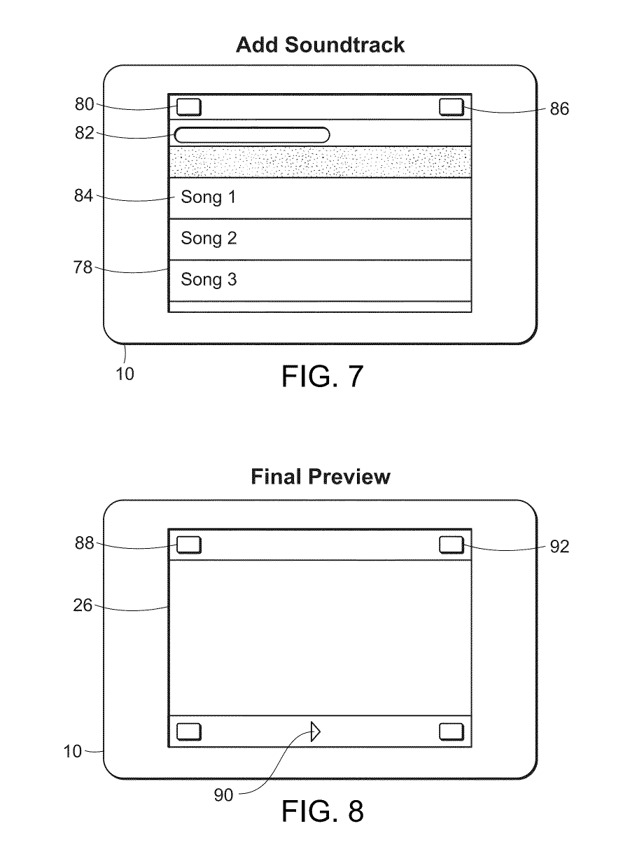

FIG. 7 is an exemplary Add Soundtrack screen 78, which allows the user to add sound (including music) to the video content from the user's music library or another source such as, e.g., an online music service. A Back button 80 can be selected to take the user to the Storyboard screen 22. The Add Soundtrack screen 78 includes a search option 80, allowing the user to enter a song name to locate a particular song. Song details 84 are shown for available songs. The details 84 can include the title of the song, the album name, and the artist named. After the user selects a song, he or she is taken to the Preview screen 26 (FIG. 8). The Add Soundtrack screen 78 can also include a Skip button 86, which also takes the user to the Final Preview screen 26.

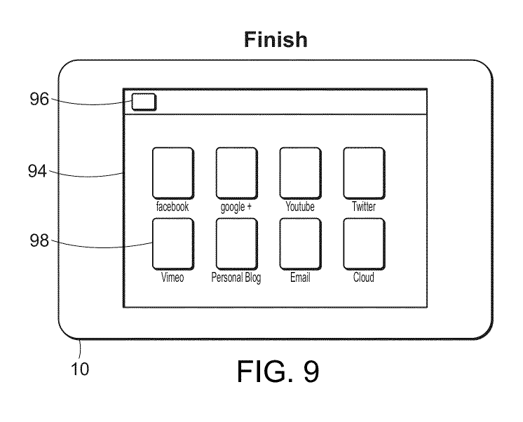

FIG. 8 is an exemplary Final Preview screen 26. The screen includes a Back button 88, which takes the user to the Add Soundtrack screen 78. The screen 26 also includes a Play button 90, which plays the video. The Play button 90 turns into a Pause button and the title disappears. A Finish button 92 can be selected to bring the user to the Finish screen 94 (FIG. 9).

FIG. 9 is an exemplary Finish screen 94. A Back button 96 on the screen takes the user to the Add Soundtrack screen 78. The Finish screen 94 includes a plurality of Share buttons 98, which allow the user to upload their video to social networking and other sites, as well as sending it by e-mail.

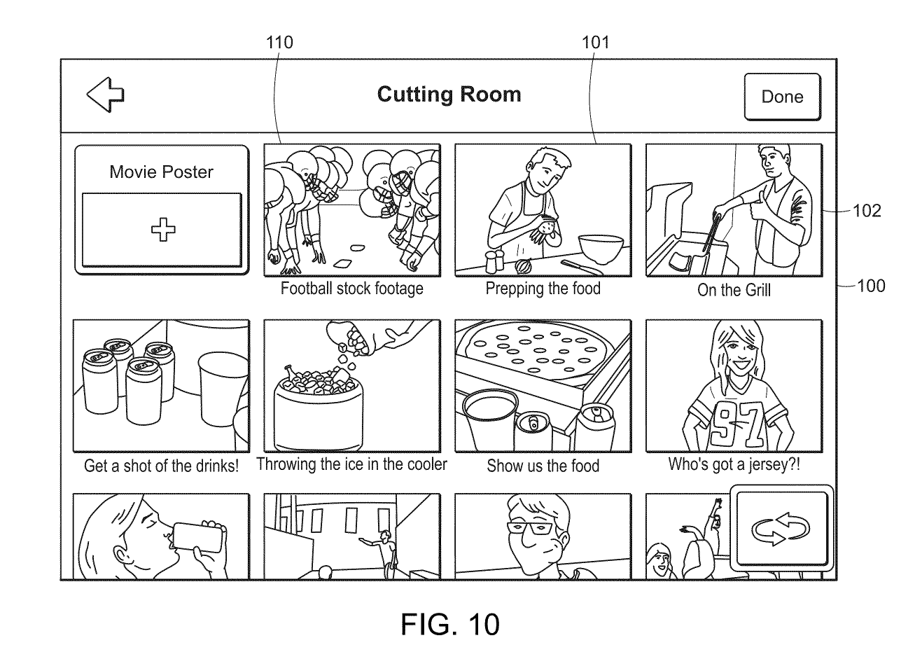

FIGS. 10 and 11 are exemplary screenshots shown on a mobile device display illustrating another example of a process for creating video content in accordance with one or more embodiments.

As discussed above, the video content system presents users with a variety of different storyboard templates that can be selected by the user based on the type of video content to be created. In the FIG. 10 example, the user has selected a storyboard template screen 100 that can be used in videotaping a sports viewing party. As shown in the figure, the storyboard template 100 comprises an arrangement of different scene elements relating to the event represented by tiles in the display, including “Prepping the food” 101 and “On the grill” 102, among others. The user can use the mobile device camera to capture video clips or still images for each of these scene elements for the videotaping project.

After the user selects a particular scene element tile in the storyboard, the mobile device camera is activated to enable the user to capture a video clip or still image for that scene element. The video system can optionally automatically activate the mobile device camera when a user selects a particular scene element tile. In accordance with one or more embodiments, the video system provides a semitransparent on-screen image overlay to help the user frame and create a particular video clip or still image. For instance, if the user selects the scene element entitled “Prepping the food” in the FIG. 10 storyboard, the mobile device camera is activated and the user is taken to a camera viewfinder screen (i.e., a shooting/filming screen) 104 as shown in FIG. 11. A semitransparent image overlay 106 (in this example, a person preparing food for the party) is shown on the viewfinder to help the user frame the video clip before shooting it. The user can arrange the subject or subjects to be filmed in the viewfinder screen 104 using the image overlay 106 as a suggestive guide before capturing the video clip or still image by pressing the record button 108.

Once the video clip or still image has been captured, the video system automatically fills the respective tile in the storyboard with the captured still image or a frame (e.g., the first frame) of the video clip as shown, e.g., in the tile 102 entitled “On the grill” shown in FIG. 10. In this way, the user knows that that filming for that scene element has been completed.

In accordance with one or more further embodiments, instead of a static image overlay, a brief animation (or other video) is shown to a user once a scene element is selected to further help guide the user in capturing the video clip. In accordance with one or more embodiments, the brief animation or other video comprises a semitransparent video overlaid on the viewfinder display of the mobile device.

In accordance with one or more further embodiments, a storyboard can contain pre-loaded content to supplement content captured by users. For example, the storyboard in FIG. 10 includes pre-loaded content in the tile 110 entitled “Football stock footage.” The video content system thereby allows users to create video content containing a combination of pre-loaded content and currently generated content.

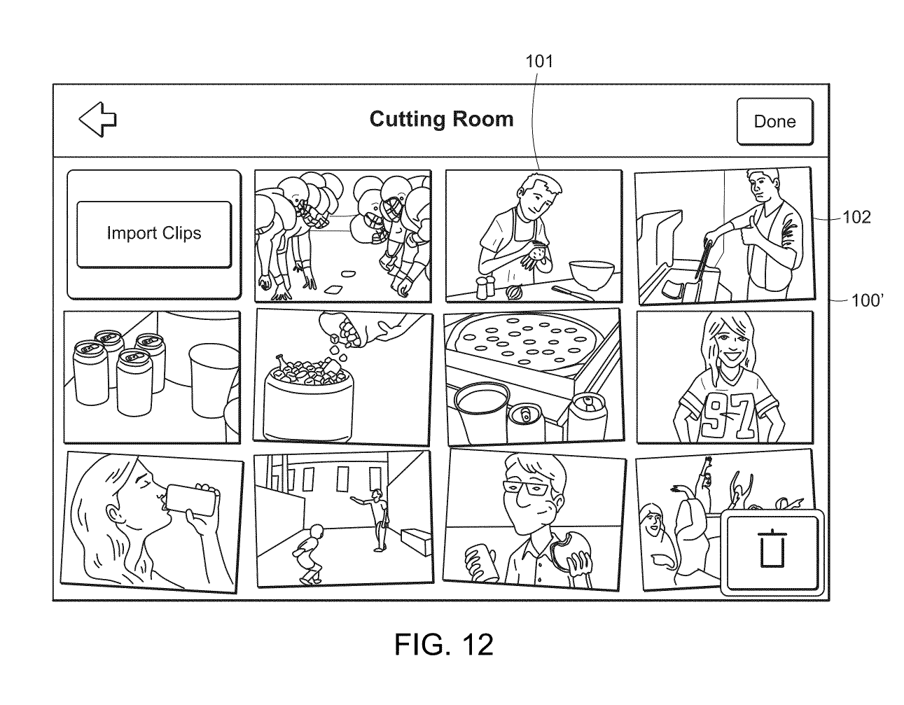

In accordance with one or more further embodiments, the video content system enables users to edit the video content by rearranging or shuffling scene elements in a storyboard so that the order of the video clips/stills taken by the user is changed in the final video content. As previously discussed, the storyboard screen 100 (e.g., as shown in FIG. 10) shows various scene elements represented by tiles for which the user has captured or is still capturing video clips/stills. The video content system combines the video clips/stills in a given order specified by the storyboard to create the final video content. In accordance with one or more embodiments, the video content system allows users to rearrange the tiles in the storyboard, and thereby the order of the video clips/stills in the final video content, by pressing a button to change the screen to a rearranging-tiles mode as shown, e.g., in FIG. 12. In this mode, the tiles are moving or wiggling as indicated by the angled display of tiles in the FIG. 12 storyboard 100′ (or some other visual cue is provided) to indicate to the user that the tiles are now movable from their respective positions in the storyboard. The user can then manually move the tiles to different positions by, e.g., touching the tiles with a finger and dragging them to desired new positions if the mobile device has a touchscreen interface.

In accordance with one or more alternate embodiments, the video content system can randomly shuffle tiles in the storyboard upon receiving an input to do so from the user. The input can, e.g., comprise a shake gesture from the user if the mobile device is capable of detecting such gestures.

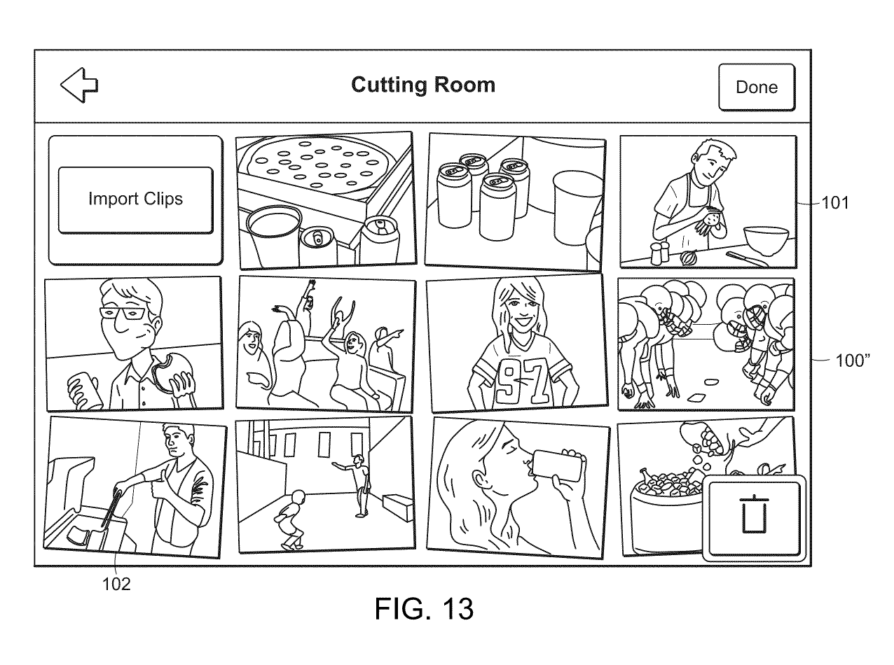

FIG. 13 illustrates one example of the storyboard 100″of FIG. 12 with shuffled tiles. As can be seen, the tiles in the FIG. 13 screen have been moved from their original places in the storyboard shown in FIG. 12.

In accordance with one or more further embodiments, the user can lock the position of selected individual tiles in the storyboard so that they do not move when the shuffle feature is activated. For instance, if the user locks selected tiles in the first and second places in the storyboard, the tiles will remain in those positions when the storyboard is shuffled again, but other tiles will be randomly rearranged.

The user can also similarly change music (or other audio) and filters (such as, e.g., a black-and-white filter or filters producing other visual effects). For instance, the user may have added a song to the video content from the user's music library or another source such as, e.g., an online music service. The video content system will change the song after receiving a user shuffle input such as a shake gesture. This can be the same user input to shuffle the video clips/stills. The video content system will, in response to the input, replace the current song with another song from the user's music library or other source. In accordance with one or more embodiments, the video content system will randomly select the new song.

As with the video clips/stills, the user can lock music (or other audio) and filters so they do not change during shuffling. Thus, the user can selectively shuffle video clips/stills, music, and filters, as desired.

The shuffle feature provides an innovative way to edit the video content. For example, the user may (1) view the video content created on the mobile device using the storyboard, (2) shake the mobile device to shuffle the video clips/stills, music, and/or filters, (3) view the new video content, (4) shake the mobile device again to reshuffle the clips/stills, music, and/or filters again if desired, and repeat until the arrangement of clips/stills, music, and/or filters is satisfactory. During this process, the user can lock in particular clips/stills, music, and/or filters in place in the storyboard and delete certain clips, music, and/or filters, if desired. In this way, the user can quickly and easily edit the video content.

It should be understood that the innovative shuffle edit feature can be implemented in any video content system that combines a plurality of video clips/stills in a final video product. Such a video content system may or may not include use of a storyboard template.

In accordance with one or more further embodiments, the video content system includes an in-line editing feature that allows users to quickly and easily trim video clips to reduce the amount of a clip that will be included in the final video content.

FIG. 14 is a screenshot illustrating an exemplary video clip editing screen 112. The video clip (in this particular example showing a plant in front of a window) is played at the center 114 of the screen. The time line 116 and play head 118 are displayed at the bottom of the screen 112. The in-line editing feature is shown at the top of the screen. The feature includes a clip preview section 120 comprising a series of selected sequential images or stills depicting the video clip in time. It also includes two trim or clip handles 122, 124 at opposite ends of the clip preview section 120. The user can grab and move each of the handles 122, 124 to trim the clip. The user can drag the left handle 122 toward the right to trim the beginning of the clip, and the user can move the right handle 124 towards the left to trim the end of the clip. For example, as shown in the screen of FIG. 15, the user has edited the clip by removing some of the beginning and some of the ending of the clip (as shown by the position of the handles 122, 124, which have been moved toward each other).

In accordance with one or more further embodiments, trim handles can be dragged and dropped at any point in the clip preview section 120 so that they can begin trimming at any point in the clip, not necessarily at the endpoints as shown in FIG. 14. The user can then move the clip handle in either direction to select portions of the clip to be removed. In this way, any selected portion, including a middle portion, of the video clip can be trimmed.

In accordance with one or more embodiments, if the user moves a handle while the clip is playing in the video clip editing screen, the video automatically pauses. Once the user has released the handle to complete a trim, the video will automatically resume playing taking into account any trimming of the video not yet played. In other words, video not yet played that has been trimmed will not be played.

The processes of the video system described above may be implemented in software, hardware, firmware, or any combination thereof. The processes are preferably implemented in one or more computer programs executing on the mobile device, which includes one or more computer processors, a storage medium readable by the one or more processors (including, e.g., volatile and non-volatile memory and/or storage elements), and input and output devices. Each computer program can be a set of instructions (program code) in a code module resident in a random access memory of the mobile device. Until required, the set of instructions may be on a remote computer system and downloaded via the Internet or other network.

Having thus described several illustrative embodiments, it is to be appreciated that various alterations, modifications, and improvements will readily occur to those skilled in the art. Such alterations, modifications, and improvements are intended to form a part of this disclosure, and are intended to be within the spirit and scope of this disclosure. While some examples presented herein involve specific combinations of functions or structural elements, it should be understood that those functions and elements may be combined in other ways according to the present disclosure to accomplish the same or different objectives. In particular, acts, elements, and features discussed in connection with one embodiment are not intended to be excluded from similar or other roles in other embodiments.

Additionally, elements and components described herein may be further divided into additional elements or components or joined together to form fewer elements or components for performing the same functions.

Accordingly, the foregoing description and attached drawings are by way of example only, and are not intended to be limiting.

What is claimed is:

1. A computer-implemented method of editing a video clip on a mobile device, comprising the steps of:
(a) presenting a video clip editing interface on a display of a mobile device operated by a user, said video clip editing interface including a section playing a video clip to be edited, said video clip editing interface also including an inline editing feature, said inline editing feature comprising a clip preview section displaying a series of selected stills depicting the video clip in time and one or more trim handles at the clip preview section;
(b) receiving a user input dragging the one or more trim handles to select a portion of the video clip to be trimmed; and
(c) pausing the video clip playing in the video clip editing interface while the user is engaging a trim handle, and resuming playing the video clip once the user is no longer engaging a trim handle without playing any portions of the video clip trimmed by the user.

2. The computer-implemented method of claim 1, wherein the one or more trim handles comprises two trim handles, each at opposite ends of the clip preview section.

3. The computer-implemented method of claim 1, wherein the user places one or more trim handles at a selected position in the clip preview section prior to (b).

4. The computer-implemented method of claim 1, wherein the display of the mobile device comprises a touch screen interface, and wherein the user input comprises the user touching and dragging a trim handle on the display to select a portion of the video clip to be trimmed.

5. The computer-implemented method of claim 1, wherein the mobile device comprises a cell phone, a personal digital assistant, a smart phone, or a tablet computer.

6. The computer-implemented method of claim 1, wherein the video clip is associated with one of a plurality of scene elements in a storyboard template presented to the user on the display of the mobile device.

7. A mobile device, comprising:
at least one processor;
memory associated with the at least one processor;
a display; and
a program supported in the memory for editing a video clip, the program having a plurality of instructions stored therein which, when executed by the at least one processor, cause the at least one processor to:
(a) present a video clip editing interface on a display of a mobile device operated by a user, said video clip editing interface including a section playing a video clip to be edited, said video clip editing interface also including an inline editing feature, said inline editing feature comprising a clip preview section displaying a series of selected stills depicting the video clip in time and one or more trim handles at the clip preview section;
(b) receive a user input dragging the one or more trim handles to select a portion of the video clip to be trimmed; and
(c) pause the video clip playing in the video clip editing interface while the user is engaging a trim handle, and resume playing the video clip once the user is no longer engaging a trim handle without playing any portions of the video clip trimmed by the user.

8. The mobile device of claim 7, wherein the one or more trim handles comprises two trim handles, each at opposite ends of the clip preview section.

9. The mobile device of claim 7, wherein the user places one or more trim handles at a selected position in the clip preview section prior to (b).

10. The mobile device of claim 7, wherein the display of the mobile device comprises a touch screen interface, and wherein the user input comprises the user touching and dragging a trim handle on the display to select a portion of the video clip to be trimmed.

11. The mobile device of claim 7, wherein the mobile device comprises a cell phone, a personal digital assistant, a smart phone, or a tablet computer.

12. The mobile device of claim 7, wherein the video clip is associated with one of a plurality of scene elements in a storyboard template presented to the user on the display of the mobile device.

13. A computer program product residing on a non-transitory computer readable medium having a plurality of instructions stored thereon which, when executed by a computer processor in a mobile device, cause that computer processor to:
(a) present a video clip editing interface on a display of the mobile device operated by a user, said video clip editing interface including a section playing a video clip to be edited, said video clip editing interface also including an inline editing feature, said inline editing feature comprising a clip preview section displaying a series of selected stills depicting the video clip in time and one or more trim handles at the clip preview section;
(b) receive a user input dragging the one or more trim handles to select a portion of the video clip to be trimmed; and
(c) pause the video clip playing in the video clip editing interface while the user is engaging a trim handle, and resume playing the video clip once the user is no longer engaging a trim handle without playing any portions of the video clip trimmed by the user.

14. The computer program product of claim 13, wherein the one or more trim handles comprises two trim handles, each at opposite ends of the clip preview section.

15. The computer program product of claim 13, wherein the user places one or more trim handles at a selected position in the clip preview section prior to (b).

16. The computer program product of claim 13, wherein the display of the mobile device comprises a touch screen interface, and wherein the user input comprises the user touching and dragging a trim handle on the display to select a portion of the video clip to be trimmed.

17. The computer program product of claim 13, wherein the mobile device comprises a cell phone, a personal digital assistant, a smart phone, or a tablet computer.

18. The computer program product of claim 13, wherein the video clip is associated with one of a plurality of scene elements in a storyboard template presented to the user on the display of the mobile device.
